(19) United States
(12) Patent Application Publication
(10) Pub. No.: US 2024/0143443 A1
(43) Pub. Date: May 2, 2024

(54) METHOD AND APPARATUS FOR REPAIRING HANGING IN COMMUNICATION BUS, ELECTRONIC DEVICE, AND STORAGE MEDIUM

(71) Applicant: INSPUR SUZHOU INTELLIGENT TECHNOLOGY CO., LTD., Suzhou, Jiangsu (CN)

(72) Inventors: Weibin KONG, Suzhou, Jiangsu (CN); Kaixin SONG, Suzhou, Jiangsu (CN); Changshun WU, Suzhou, Jiangsu (CN)

(21) Appl. No.: 18/281,290

(22) PCT Filed: May 26, 2022
(86) PCT No.: PCT/CN2022/095361

§ 371 Date: Sep. 9, 2023

(30) Foreign Application Priority Data
Oct. 8, 2021 (CN) 202111168144.4

(51) Int. Cl. G06F 11/14; G06F 13/42

(52) U.S. Cl. CPC G06F 11/141; G06F 13/4291; G06F 2213/0016

(57) ABSTRACT

The present disclosure discloses a method for repairing hanging-up of a communication bus, an apparatus, an electronic device and a storage medium. The method includes: detecting a communication situation between the central processing unit and a baseband processing unit; when the communication situation is used to indicate a communication fault between the central processing unit and the baseband processing unit, determining a target hanging-up event generated by the communication bus deployed between the central processing unit and the baseband processing unit; obtaining a target repairing operation corresponding to the target hanging-up event; and according to the target repairing operation, repairing the communication bus.

### CROSS REFERENCE TO RELEVANT APPLICATIONS

The present disclosure claims the priority of the Chinese patent application filed on Oct. 8, 2021 before the Chinese Patent Office with the application number of 202111168144.4 and the title of “METHOD AND APPARATUS FOR REPAIRING HANGING IN COMMUNICATION BUS, ELECTRONIC DEVICE, AND STORAGE MEDIUM”, which is incorporated herein in its entirety by reference.

### TECHNICAL FIELD

The present disclosure relates to the technical field of computers and, more particularly, to a method for repairing hanging-up of a communication bus, an apparatus, an electronic device and a storage medium.

### BACKGROUND

The inter-integrated circuit bus (I2C) is designed by the NXP (the original PHILIPS) company, and is mostly used for the master-slave communication between the master controller and the slave devices. It is used in scenes of a small data volume, and has characteristics such as a short transmission distance and that, at any moment, there may merely be one mainframe.

The physical layer of the IIC bus requires merely two buses, wherein one of the two buses is a serial data line SDA, and the other is a serial clock line SCL. The IIC is half duplex, rather than full duplex. Each of the devices connected to the bus may communicate with the other devices by using a unique address, the roles and the addresses of the mainframe or the slaves are configurable, and the mainframe may serve as the mainframe sender and the mainframe receiver. At a same moment, the IIC is a true multi-mainframe bus, and when two or more mainframes simultaneously request the bus, by the collision detection and arbitration, the bus data may be prevented from being destroyed. The transmission speed may reach 100 kb/s in a standard mode, and the transmission speed may reach 400 kb/s in a quick mode.

Currently, the Hygon CPU supports 5 IIC buses, wherein the central processing unit (CPU) supports the accessing of at most 16 dual inline memory modules (DIMMs). The IIC bus of the baseband processing unit (BBU) is mounted on the IIC1 channel of the CPU. There is one single ST MCU single chip microcomputer on the BBU board. That single chip microcomputer realizes the function of electricity backup and decoupling of the BBU, and in starting-up or rebooting, the ST single chip microcomputer has a scene where the IIC is the master, to determine whether the BBU battery is a first source of goods or a second source of goods. In the IIC1 bus, the IIC1 of the Hygon CPU is the controller, but the inventor envisages that, in the bus, the Hygon CPU and the ST MCU have the scene where the IIC has double masters, which causes that the IIC bus has a competitive relation, whereby the problem of hanging-up of the IIC bus happens.

### SUMMARY

According to one aspect of the embodiments of the present disclosure, a method for repairing hanging-up of a communication bus is provided, wherein the method is applied to a central processing unit, and the method includes:
detecting a communication situation between the central processing unit and a baseband processing unit;
when the communication situation is used to indicate a communication fault situation between the central processing unit and the baseband processing unit, determining a target hanging-up event generated by the communication bus deployed between the central processing unit and the baseband processing unit;
obtaining a target repairing operation corresponding to the target hanging-up event; and
according to the target repairing operation, repairing the communication bus.

In one of the embodiments, determining the target hanging-up event generated by the communication bus deployed between the central processing unit and the baseband processing unit includes:
detecting a target connecting mode at a current moment between the central processing unit and the baseband processing unit; and
according to the target connecting mode, determining the target hanging-up event generated by the communication bus, wherein the target hanging-up event includes a serial-data-line hanging-up event and a serial-clock-line hanging-up event.

In one of the embodiments, the target connecting mode includes:
the central processing unit is connected to the baseband processing unit by the communication bus;
or
the central processing unit is serially connected to a hot-plug chip and the baseband processing unit by the communication bus.

In one of the embodiments, according to the target connecting mode, determining the target hanging-up event generated by the communication bus includes:
when the target connecting mode is that the central processing unit is connected to the baseband processing unit by the communication bus, the target hanging-up event is the serial-clock-line hanging-up event; and
when the target connecting mode is that the central processing unit is serially connected to the hot-plug chip and the baseband processing unit by the communication bus, the target hanging-up event is the serial-data-line hanging-up event.

In one of the embodiments, when the target hanging-up event is the serial-clock-line hanging-up event, according to the target repairing operation, repairing the communication bus includes:
switching the central processing unit to a general purpose input/output (GPIO) inputting mode;
when the central processing unit changes from a high level to a low level in the GPIO inputting mode, switching the central processing unit from the GPIO inputting mode to a GPIO outputting mode; and
when the central processing unit changes from the low level to the high level in the GPIO outputting mode, switching the central processing unit from the GPIO outputting mode to an IIC mode.

In one of the embodiments, when the target hanging-up event is the serial-data-line hanging-up event, according to the target repairing operation, repairing the communication bus includes:
when it is detected that the baseband processing unit is in a pulling-out state, sending a first controlling instruction to a programing logic device corresponding to the hot-plug chip, wherein the first controlling instruction is configured for controlling the programing logic device to stop supplying electric power to the hot-plug chip;
after the hot-plug chip stops operating, detecting a plugging state of the baseband processing unit; and
when the plugging state is configured for indicating that the baseband processing unit is in an insertion state, sending a second controlling instruction to the programing logic device, wherein the second controlling instruction is configured for controlling the programing logic device to start supplying the electric power to the hot-plug chip.

In one of the embodiments, sending the second controlling instruction to the programing logic device includes:
after delaying for a predetermined duration, sending the second controlling instruction to the programing logic device;
or
detecting an initialization progress after the baseband processing unit is inserted, and when the initialization progress reaches a predetermined progress, sending the second controlling instruction to the programing logic device.

According to another aspect of the embodiments of the present disclosure, an apparatus for repairing hanging-up of a communication bus is further provided, wherein the apparatus includes:
a detecting module configured for detecting a communication situation between a central processing unit and a baseband processing unit;
a determining module configured for, when the communication situation is used to indicate a communication fault situation between the central processing unit and the baseband processing unit, determining a target hanging-up event generated by the communication bus deployed between the central processing unit and the baseband processing unit;
an obtaining module configured for obtaining a target repairing operation corresponding to the target hanging-up event; and
an executing module configured for, according to the target repairing operation, repairing the communication bus.

According to another aspect of the embodiments of the present disclosure, one or more non-volatile computer-readable storage mediums storing a computer-readable instruction is further provided, wherein the computer-readable instruction, when executed by one or more processors, causes the one or more processors to implement the steps of the method for repairing hanging-up of a communication bus according to any one of the above embodiments. According to another aspect of the embodiments of the present disclosure, an electronic device is further provided, wherein the electronic device includes a memory and one or more processors, the memory stores a computer-readable instruction, and the computer-readable instruction, when executed by the one or more processors, causes the one or more processors to implement the steps of the method for repairing hanging-up of a communication bus according to any one of the above embodiments.

An embodiment of the present disclosure further provides a computer program product containing a computer-readable instruction, wherein the computer-readable instruction, when executed in a computer, causes the computer to implement the steps of the method for repairing hanging-up of a communication bus according to any one of the above embodiments.

The details of one or more embodiments of the present disclosure are provided in the following drawings and description. The other characteristics and advantages of the present disclosure may become apparent from the description, the drawings and the claims.

### BRIEF DESCRIPTION OF THE DRAWINGS

The drawings here are incorporated into the description and form a part of the description. The drawings show the embodiments that comply with the present disclosure, and are used to interpret the principle of the present disclosure together with the description.

In order to more clearly illustrate the technical solutions of the embodiments of the present disclosure or the prior art, the figures that are required to be used to describe the embodiments or the prior art may be briefly described below. Apparently, a person skilled in the art may obtain other figures according to these figures without paying creative work.

FIG. 1 is a flow chart of a method for repairing hanging-up of a communication bus according to one or more embodiments of the present disclosure;

FIG. 2 is a flow chart of a method for repairing hanging-up of a communication bus according to one or more embodiments of the present disclosure;

FIG. 3 is a schematic diagram of the connection between the central processing unit and the baseband processing unit according to one or more embodiments of the present disclosure;

FIG. 4 is a flow chart of a method for repairing hanging-up of a communication bus according to one or more embodiments of the present disclosure;

FIG. 5 is a flow chart of a method for repairing hanging-up of a communication bus according to one or more embodiments of the present disclosure;

FIG. 6 is a block diagram of an apparatus for repairing hanging-up of a communication bus according to one or more embodiments of the present disclosure; and

FIG. 7 is a schematic structural diagram of an electronic device according to one or more embodiments of the present disclosure.

### DETAILED DESCRIPTION

In order to make the objects, the technical solutions and the advantages of the embodiments of the present disclosure clearer, the technical solutions in the embodiments of the present disclosure may be clearly and completely described below with reference to the drawings in the embodiments of the present disclosure. Apparently, the described embodiments are merely certain embodiments of the present disclosure, rather than all of the embodiments. The illustrative embodiments of the present disclosure and their explanation are intended to interpret the present disclosure, and do not constitute an inappropriate limitation to the present disclosure. All of the other embodiments that a person skilled in the art obtains on the basis of the embodiments of the present disclosure without paying creative work fall within the protection scope of the present disclosure.

It should be noted that, in the present text, relation terms such as “first” and “second” are merely intended to distinguish one entity or operation from another similar entity or operation, and that does not necessarily require or imply that there are any such actual relation or order between those entities or operations. Furthermore, the terms “include”, “comprise” or any variants thereof are intended to cover non-exclusive inclusions, so that processes, methods, articles or devices that include a series of elements do not only include those elements, but also include other elements that are not explicitly listed, or include the elements that are inherent to such processes, methods, articles or devices. Unless further limitation is set forth, an element defined by the wording “including a . . . ” does not exclude additional same element in the process, method, article or device including the element.

The embodiments of the present disclosure provide a method for repairing hanging-up of a communication bus, an apparatus, an electronic device and a storage medium. The method according to the embodiments of the present disclosure may be applied to any required electronic device, for example, an electronic device such as a server and a terminal, which is not limited herein, and, in order to facilitate the description, the any required electronic device is referred to for short as an electronic device subsequently.

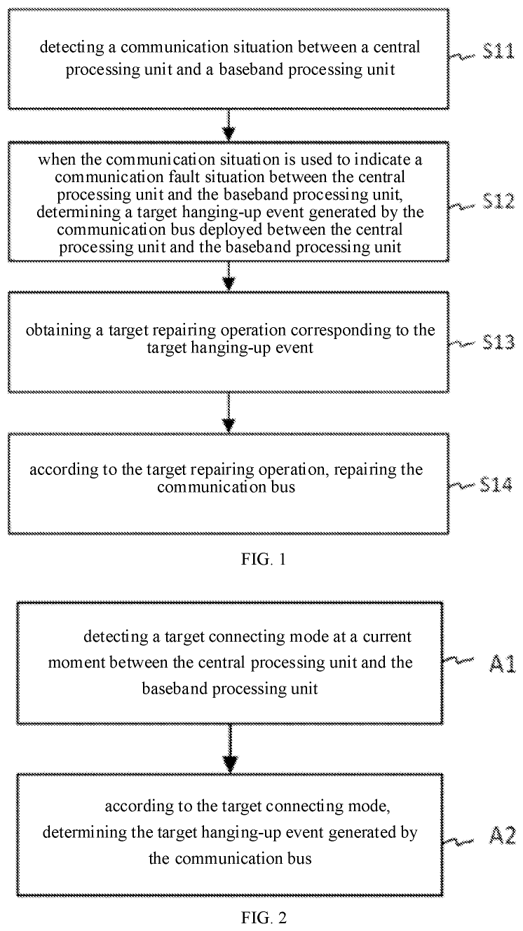

According to one aspect of the embodiments of the present disclosure, an embodiment of a method for repairing hanging-up of a communication bus is provided, wherein the method is applied to a central processing unit. FIG. 1 is a flow chart of a method for repairing hanging-up of a communication bus according to an embodiment of the present disclosure. As shown in FIG. 1, the method includes:

Step S11: detecting a communication situation between the central processing unit and a baseband processing unit.

The method according to the embodiments of the present disclosure is designed with respect to the problem that hanging-up of the communication bus between the central processing unit and the baseband processing unit cannot be repaired automatically, wherein the central processing unit may be a Hygon CPU, and the baseband processing unit is a building base band unite (BBU).

In an embodiment of the present disclosure, the central processing unit may randomly or periodically detect the communication situation with the baseband processing unit, for example, by obtaining the data transmission parameters on the communication bus deployed between the central processing unit and the baseband processing unit, for example, the transmission speed and the transmission amount and so on, and subsequently, according to the transmission parameters, determining the communication situation between the central processing unit and the baseband processing unit.

Step S12: when the communication situation is used to indicate a communication fault situation between the central processing unit and the baseband processing unit, determining a target hanging-up event generated by the communication bus deployed between the central processing unit and the baseband processing unit.

In an embodiment of the present disclosure, the hanging-up event includes a serial-data-line hanging-up event and a serial-clock-line hanging-up event.

It should be noted that the serial-data-line hanging-up event may be caused by the following operations. When the central processing unit is writing data or addresses into the baseband processing unit, if the baseband processing unit emits an acknowledgment (ACK) response, then it pulls down the SDA during the clock signal. Alternatively, when the central processing unit is reading data from the baseband processing unit, the baseband processing unit pulls down the SDA during the corresponding clock signal when bit is 0. The serial-clock-line hanging-up event may be caused by the following operations: that the I2C interruption service program is accidentally shielded, that the interruption service program falls into a while infinite loop of some flag-bit inquiries, that the I2C function system is accidentally forbidden, and so on.

In an embodiment of the present disclosure, determining the target hanging-up event generated by the communication bus deployed between the central processing unit and the baseband processing unit, as shown in FIG. 2, includes the following steps A1-A2:

Step A1: detecting a target connecting mode at a current moment between the central processing unit and the baseband processing unit.

In an embodiment of the present disclosure, the connecting mode between the central processing unit and the baseband processing unit includes that the central processing unit is connected to the baseband processing unit by the communication bus. In this mode, the hot-plug chip is in the pulling-out state, and at this moment, the central processing unit is directly connected to the baseband processing unit by the communication bus.

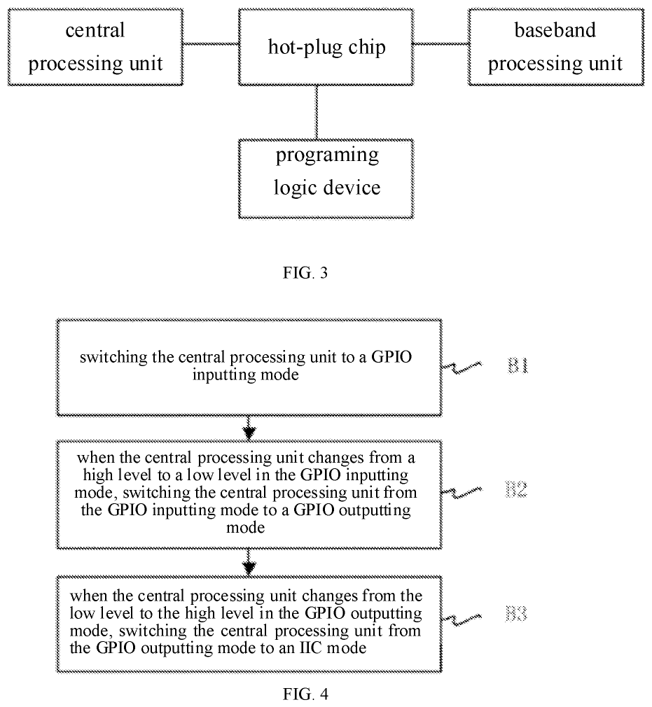

In an embodiment of the present disclosure, the connecting mode between the central processing unit and the baseband processing unit may also be that the central processing unit is serially connected to a hot-plug chip and the baseband processing unit by the communication bus. Referring to FIG. 3, the central processing unit is bidirectionally connected to the hot-plug chip by the communication bus, and the hot-plug chip is bidirectionally connected to the baseband processing unit by the communication bus.

Step A2: according to the target connecting mode, determining the target hanging-up event generated by the communication bus.

In an embodiment of the present disclosure, according to the target connecting mode, determining the target hanging-up event generated by the communication bus includes: when the target connecting mode is that the central processing unit is connected to the baseband processing unit by the communication bus, the target hanging-up event is the serial-clock-line hanging-up event; and when the target connecting mode is that the central processing unit is serially connected to the hot-plug chip and the baseband processing unit by the communication bus, the target hanging-up event is the serial-data-line hanging-up event.

Step S13: obtaining a target repairing operation corresponding to the target hanging-up event.

In an embodiment of the present disclosure, the different hanging-up events have different event types, and they correspond to different repairing operations. For example, when the hanging-up event is the serial-clock-line hanging-up event, the corresponding repairing operation may be to switch to the GPIO mode of the central processing unit. When the hanging-up event is the serial-data-line hanging-up event, the corresponding repairing operation may be to control the hot-plug chip.

Step S14: according to the target repairing operation, repairing the communication bus.

In an embodiment of the present disclosure, when the target hanging-up event is the serial-clock-line hanging-up event, the step S14 of, according to the target repairing operation, repairing the communication bus, as shown in FIG. 4, includes the following steps B1-B3:

Step B1: switching the central processing unit to a GPIO inputting mode.

Step B2: when the central processing unit changes from a high level to a low level in the GPIO inputting mode, switching the central processing unit from the GPIO inputting mode to a GPIO outputting mode.

Step B3: when the central processing unit changes from the low level to the high level in the GPIO outputting mode, switching the central processing unit from the GPIO outputting mode to an IIC mode.

In an embodiment of the present disclosure, in the case of hanging-up of the serial clock line, when the Hygon CPU is directly set at the high level in the IIC mode, then that causes the Hygon CPU to be damaged. Therefore, in order to solve the problem that the Hygon CPU is damaged when set at the high level directly in the IIC mode, in an embodiment of the present disclosure, when the serial-clock-line hanging-up event happens, the central processing unit is switched from the IIC mode to the GPIO inputting mode (i.e., the inputting mode of GPIO); in the inputting mode of GPIO, a high level and a low level are set according to a predetermined sequence; after the setting is completed, the central processing unit is switched from the GPIO inputting mode to the GPIO outputting mode (i.e., the outputting mode of GPIO); in the GPIO outputting mode, a low level and a high level are set according to a predetermined sequence; and after the central processing unit recovers to the high level, the central processing unit is switched from the GPIO outputting mode to the IID mode, at this moment, the central processing unit may be normally used in the IIC mode.

In the embodiment of the present disclosure, the high level is set by using a way of switching the GPIO inputting mode and the GPIO outputting mode, which has the effect of buffering, and may effectively solve the problem that the Hygon CPU is damaged when the high level is set directly in the IIC mode.

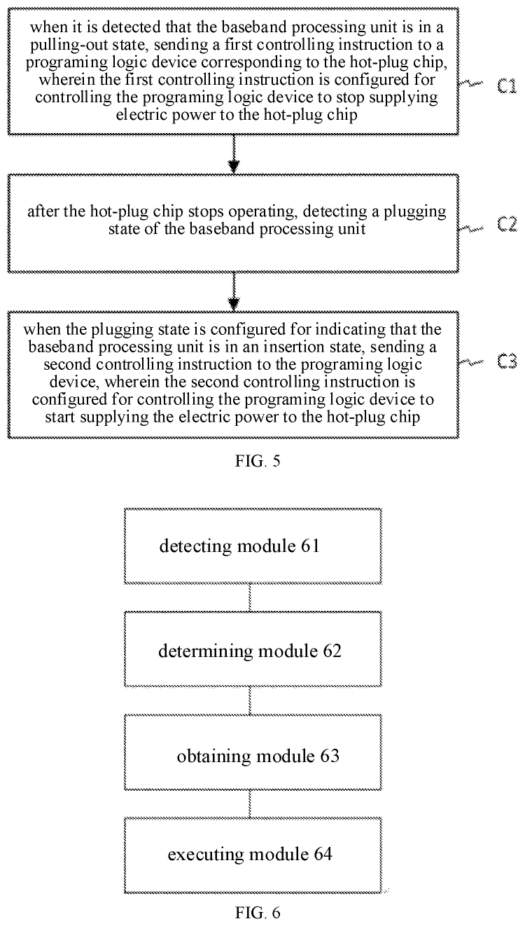

In an embodiment of the present disclosure, when the target hanging-up event is the serial-data-line hanging-up event, the step S14 of, according to the target repairing operation, repairing the communication bus, as shown in FIG. 5, includes the following steps C1-C3:

Step C1: when it is detected that the baseband processing unit is in a pulling-out state, sending a first controlling instruction to a programing logic device corresponding to the hot-plug chip, wherein the first controlling instruction is configured for controlling the programing logic device to stop supplying electric power to the hot-plug chip.

Step C2: after the hot-plug chip stops operating, detecting a plugging state of the baseband processing unit.

Step C3: when the plugging state is configured for indicating that the baseband processing unit is in an insertion state, sending a second controlling instruction to the programing logic device, wherein the second controlling instruction is configured for controlling the programing logic device to start supplying the electric power to the hot-plug chip.

In an embodiment of the present disclosure, when the target hanging-up event is the serial-data-line hanging-up event, the central processing unit sends a detecting instruction to a programing logic device corresponding to the hot-plug chip, to cause the programing logic device to detect the plugging state of the baseband processing unit, and, when it is detected that the baseband processing unit is in a pulling-out state, sends a first controlling instruction to the programing logic device corresponding to the hot-plug chip, to cause the programing logic device to stop supplying the electric power to the hot-plug chip, to ensure that, after the baseband processing unit is pulled out, the hot-plug chip is shocked.

In addition, subsequently, after the hot-plug chip stops operating, the central processing unit may further control the programing logic device to continue detecting the plugging state of the baseband processing unit, and, when it is detected that the baseband processing unit is in a pulling-out state, a second controlling instruction is sent to the programing logic device corresponding to the hot-plug chip, to cause the programing logic device to start supplying the electric power to the hot-plug chip, to recover the normal communication. In an embodiment of the present disclosure, the programing logic device is a CPLD, and the CPLD is mainly formed by three parts, which are a logical block, a programmable interconnection channel and an I/O block.

In an embodiment of the present disclosure, sending the second controlling instruction to the programing logic device includes: after delaying for a predetermined duration, sending the second controlling instruction to the programing logic device; or detecting an initialization progress after the baseband processing unit is inserted, and when the initialization progress reaches a predetermined progress, sending the second controlling instruction to the programing logic device.

It should be noted that, in the embodiment of the present disclosure, after delaying for a predetermined duration, the central processing unit sends the second controlling instruction to the programing logic device, which facilitates to ensure that the baseband processing unit may have sufficient time to complete the initialization, whereby the single chip microcomputer in the baseband processing unit completes the acquirement with respect to whether the battery is a first source of goods or a second source of goods. In addition, the embodiment of the present disclosure may, by detecting the initialization progress after the baseband processing unit is inserted, determine whether the baseband processing unit has completed the initialization, which facilitates the programing logic device to supply the electric power to the hot-plug chip timely.

In the embodiments of the present disclosure, in the case of a communication fault between the central processing unit and the baseband processing unit, the target hanging-up event generated by the communication bus may be automatically determined, and the repairing operation corresponding to the target hanging-up event is executed, the automatic repairing is realized in the case of hanging-up of the communication bus, and the stability of the central processing unit in operation is improved.

FIG. 6 is a block diagram of an apparatus for repairing hanging-up of a communication bus according to an embodiment of the present disclosure. The apparatus may become a part or the whole of an electronic device by being embodied as software, hardware or a combination thereof. As shown in FIG. 6, the apparatus includes:
a detecting module 61 configured for detecting a communication situation between a central processing unit and a baseband processing unit;
a determining module 62 configured for, when the communication situation is used to indicate a communication fault situation between the central processing unit and the baseband processing unit, determining a target hanging-up event generated by the communication bus deployed between the central processing unit and the baseband processing unit;
an obtaining module 63 configured for obtaining a target repairing operation corresponding to the target hanging-up event; and
an executing module 64 configured for, according to the target repairing operation, repairing the communication bus.
In an embodiment of the present disclosure, the determining module 62 includes:
a processing sub-module configured for detecting a target connecting mode at a current moment between the central processing unit and the baseband processing unit; and
a determining sub-module configured for, according to the target connecting mode, determining the target hanging-up event generated by the communication bus, wherein the target hanging-up event includes a serial-data-line hanging-up event and a serial-clock-line hanging-up event.

In an embodiment of the present disclosure, the target connecting mode includes: the central processing unit is connected to the baseband processing unit by the communication bus; or the central processing unit is serially connected to a hot-plug chip and the baseband processing unit by the communication bus.

In an embodiment of the present disclosure, the determining sub-module is configured to that, when the target connecting mode is that the central processing unit is connected to the baseband processing unit by the communication bus, the target hanging-up event is the serial-clock-line hanging-up event; and when the target connecting mode is that the central processing unit is serially connected to the hot-plug chip and the baseband processing unit by the communication bus, the target hanging-up event is the serial-data-line hanging-up event.

In an embodiment of the present disclosure, when the target hanging-up event is the serial-clock-line hanging-up event, the executing module 64 is configured for switching the central processing unit to a GPIO inputting mode; when the central processing unit changes from a high level to a low level in the GPIO inputting mode, switching the central processing unit from the GPIO inputting mode to a GPIO outputting mode; and when the central processing unit changes from the low level to the high level in the GPIO outputting mode, switching the central processing unit from the GPIO outputting mode to an IIC mode.

In an embodiment of the present disclosure, when the target hanging-up event is the serial-data-line hanging-up event, the executing module 64 is configured for, when it is detected that the baseband processing unit is in a pulling-out state, sending a first controlling instruction to a programing logic device corresponding to the hot-plug chip, wherein the first controlling instruction is configured for controlling the programing logic device to stop supplying electric power to the hot-plug chip; after the hot-plug chip stops operating, detecting a plugging state of the baseband processing unit; and when the plugging state is configured for indicating that the baseband processing unit is in an insertion state, sending a second controlling instruction to the programing logic device, wherein the second controlling instruction is configured for controlling the programing logic device to start supplying the electric power to the hot-plug chip.

In an embodiment of the present disclosure, when the target hanging-up event is the serial-data-line hanging-up event, the executing module 64 is further configured for, after delaying for a predetermined duration, sending the second controlling instruction to the programing logic device; or detecting an initialization progress after the baseband processing unit is inserted, and when the initialization progress reaches a predetermined progress, sending the second controlling instruction to the programing logic device.

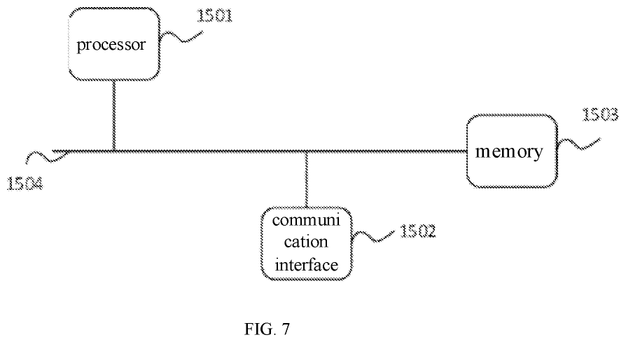

An embodiment of the present disclosure further provides an electronic device. As shown in FIG. 7, the electronic device may be a computer device, the computer device may be a terminal or server, the electronic device may include a processor 1501, a communication interface 1502, a memory 1503 and a communication bus 1504, wherein the processor 1501, the communication interface 1502 and the memory 1503 complete the communication therebetween via the communication bus 1504.

The memory 1503 is configured for storing a computer-readable instruction.

The one or more processors 1501 are configured for executing the computer-readable instruction stored in the memory 1503, and the computer-readable instruction, when executed by the processors 1501, implements the steps of the method for repairing hanging-up of a communication bus according to any one of the above embodiments.

The communication bus may be a peripheral component interconnect (referred to for short as PCI) bus or an extended industry standard architecture (referred to for short as EISA) bus and so on. The communication bus may be divided to be an address bus, a data bus, a control bus and so on. In order to facilitate the illustration, it is merely represented by a thick line in the figure, but that does not mean that there is merely one bus or one type of bus.

The communication interface is used for the communication between the above terminals and other devices.

The memory may include a random access memory (referred to for short as RAM), and may also include a non-volatile memory, for example, at least one disk storage. The memory may also be at least one storage device located remotely from the processor.

The processor may be a generic processor, including a central processing unit (referred to for short as CPU), a network processor (referred to for short as NP) and so on. The processor may also be a digital signal processing (referred to for short as DSP), an application integrated circuit (referred to for short as ASIC), a field-programmable gate array (referred to for short as FPGA), or other programmable logic device, discrete gate or transistor logic device, or discrete hardware component.

In another embodiment of the present disclosure, a non-volatile computer-readable storage medium is further provided, wherein the non-volatile computer-readable storage medium stores a computer-readable instruction, and the computer-readable instruction, when executed by one or more processors, may implement the steps of the method for repairing hanging-up of a communication bus according to any one of the above embodiments.

In yet another embodiment of the present disclosure, there is further provided a computer program product containing a computer-readable instruction, wherein the computer program product, when executed in a computer, causes the computer to implement the method for repairing hanging-up of a communication bus according to any one of the above embodiments.

A person skilled in the art may understand that all or some of the processes of the methods in the above embodiments may be implemented by that a computer-readable instruction instructs relative hardware, the computer-readable instruction may be stored in a non-volatile computer-readable storage medium, and the computer-readable instruction, when executed, may contain the processes of the embodiments of the method stated above. Any reference to a memory, a storage, a database or other medium used in the embodiments provided by the present disclosure may include a non-volatile and/or volatile memory. The non-volatile memory may include a read-only memory (ROM), a programmable ROM (PROM), an electrically programmable ROM (EPROM), an electrically erasable programmable ROM (EEPROM) or a flash memory. The volatile memory may include a random access memory (RAM) or an external cache memory. As explanation rather than limitation, the RAM may be embodied in various forms, such as a static RAM (SRAM), a dynamic RAM (DRAM), a synchronous DRAM (SDRAM), a double-data-rate SDRAM (DDRSDRAM), an enhanced SDRAM (ESDRAM), a synchlink DRAM (SLDRAM), a rambus direct RAM (RDRAM), a direct-memory-bus dynamic RAM (DRDRAM), a memory-bus dynamic RAM (RDRAM) and so on.

The above embodiments may be implemented totally or partially by software, hardware, firmware or any combination thereof. When they are implemented by software, they may be implemented totally or partially in the form of a computer program product. The computer program product includes one or more computer-readable instructions. When the computer program instructions are loaded and executed in a computer, they totally or partially generate the process or functions according to the embodiments of the present disclosure. The computer may be a general-purpose computer, a special-purpose computer, a computer network or another programmable device. The computer-readable instructions may be stored in a computer-readable storage medium, or be transmitted from a computer-readable storage medium to another computer-readable storage medium. For example, the computer-readable instructions may be transmitted from a web site, a computer, a server or a data center to another web site, a computer, a server or a data center in a wired (for example, a coaxial cable, an optical fiber and a digital subscriber line) or wireless (for example, infrared, wireless and microwave) manner. The computer-readable storage medium may be any usable medium that may be accessed by a computer or a data storage device that includes one or more integrated usable mediums such as a server and a data center. The usable medium may be a magnetic medium (for example, a floppy disk, a hard disk and a magnetic tape), an optical medium (for example, a DVD), a semiconductor medium (for example, a solid state disk) and so on.

The above description is merely preferable embodiments of the present disclosure, and is not limiting the protection scope of the present disclosure. Any modifications, equivalent substitutions and improvements that are made within the spirit and the principle of the present disclosure should fall within the protection scope of the present disclosure.

The above are merely embodiments of the present disclosure, to enable a person skilled in the art to comprehend or implement the present disclosure. Various modifications on those embodiments may be apparent to a person skilled in the art, and the general principle defined herein may be implemented in other embodiments without departing from the spirit or scope of the present disclosure. Therefore, the present disclosure should not be limited to the embodiments illustrated herein, but should meet the broadest scope in accord with the principle and the novel characteristics disclosed herein.

1. A method for repairing hanging-up of a communication bus, applied to a central processing unit, comprising:
detecting a communication situation between the central processing unit and a baseband processing unit;
when the communication situation is used to indicate a communication fault situation between the central processing unit and the baseband processing unit, determining a target hanging-up event generated by the communication bus deployed between the central processing unit and the baseband processing unit;
obtaining a target repairing operation corresponding to the target hanging-up event; and
according to the target repairing operation, repairing the communication bus.

2. The method according to claim 1, wherein determining the target hanging-up event generated by the communication bus deployed between the central processing unit and the baseband processing unit comprises:
detecting a target connecting mode at a current moment between the central processing unit and the baseband processing unit; and
according to the target connecting mode, determining the target hanging-up event generated by the communication bus, wherein the target hanging-up event comprises a serial-data-line hanging-up event and a serial-clock-line hanging-up event.

3. The method according to claim 2, wherein the target connecting mode comprises:
the central processing unit is connected to the baseband processing unit by the communication bus;
or
the central processing unit is serially connected to a hot-plug chip and the baseband processing unit by the communication bus.

4. The method according to claim 3, wherein according to the target connecting mode, determining the target hanging-up event generated by the communication bus comprises:
when the target connecting mode is that the central processing unit is connected to the baseband processing unit by the communication bus, the target hanging-up event is the serial-clock-line hanging-up event; and
when the target connecting mode is that the central processing unit is serially connected to the hot-plug chip and the baseband processing unit by the communication bus, the target hanging-up event is the serial-data-line hanging-up event.

5. The method according to claim 3, wherein when the target hanging-up event is the serial-clock-line hanging-up event, according to the target repairing operation, repairing the communication bus comprises:
switching the central processing unit to a general purpose input/output (GPIO) inputting mode;
when the central processing unit changes from a high level to a low level in the GPIO inputting mode, switching the central processing unit from the GPIO inputting mode to a GPIO outputting mode; and
when the central processing unit changes from the low level to the high level in the GPIO outputting mode, switching the central processing unit from the GPIO outputting mode to an IIC mode.

6. The method according to claim 3, wherein when the target hanging-up event is the serial-data-line hanging-up event, according to the target repairing operation, repairing the communication bus comprises:
when it is detected that the baseband processing unit is in a pulling-out state, sending a first controlling instruction to a programing logic device corresponding to the hot-plug chip, wherein the first controlling instruction is configured for controlling the programing logic device to stop supplying electric power to the hot-plug chip;
after the hot-plug chip stops operating, detecting a plugging state of the baseband processing unit; and
when the plugging state is configured for indicating that the baseband processing unit is in an insertion state, sending a second controlling instruction to the programing logic device, wherein the second controlling instruction is configured for controlling the programing logic device to start supplying the electric power to the hot-plug chip.

7. The method according to claim 6, wherein sending the second controlling instruction to the programing logic device comprises:
after delaying for a predetermined duration, sending the second controlling instruction to the programing logic device;
or
detecting an initialization progress after the baseband processing unit is inserted, and when the initialization progress reaches a predetermined progress, sending the second controlling instruction to the programing logic device.

8. (canceled)

9. One or more non-volatile computer-readable storage mediums storing a computer-readable instruction, wherein the computer-readable instruction, when executed by one or more processors, causes the one or more processors to implement the steps of the method according to claim 1.

10. An electronic device, wherein the electronic device comprises a memory and one or more processors, the memory stores a computer-readable instruction, and the computer-readable instruction, when executed by the one or more processors, causes the one or more processors to implement the steps of the method according to claim 1.

11. The method according to claim 1, wherein detecting the communication situation between the central processing unit and the baseband processing unit comprises:
obtaining data transmission parameters on the communication bus deployed between the central processing unit and the baseband processing unit; and
according to the data transmission parameters, determining the communication situation between the central processing unit and the baseband processing unit.

12. The method according to claim 11, wherein the data transmission parameters comprises: a transmission speed and a transmission amount.

13. The method according to claim 3, wherein that the central processing unit is serially connected to the hot-plug chip and the baseband processing unit by the communication bus comprises:
the central processing unit is bidirectionally connected to the hot-plug chip by the communication bus; and
the hot-plug chip is bidirectionally connected to the baseband processing unit by the communication bus.

14. The electronic device according to claim 10, wherein determining the target hanging-up event generated by the communication bus deployed between the central processing unit and the baseband processing unit comprises:
detecting a target connecting mode at a current moment between the central processing unit and the baseband processing unit; and
according to the target connecting mode, determining the target hanging-up event generated by the communication bus, wherein the target hanging-up event comprises a serial-data-line hanging-up event and a serial-clock-line hanging-up event.

15. The electronic device according to claim 14, wherein the target connecting mode comprises:
the central processing unit is connected to the baseband processing unit by the communication bus;
or
the central processing unit is serially connected to a hot-plug chip and the baseband processing unit by the communication bus.

16. The electronic device according to claim 15, wherein according to the target connecting mode, determining the target hanging-up event generated by the communication bus comprises:
when the target connecting mode is that the central processing unit is connected to the baseband processing unit by the communication bus, the target hanging-up event is the serial-clock-line hanging-up event; and
when the target connecting mode is that the central processing unit is serially connected to the hot-plug chip and the baseband processing unit by the communication bus, the target hanging-up event is the serial-data-line hanging-up event.

17. The electronic device according to claim 15, wherein when the target hanging-up event is the serial-clock-line hanging-up event, according to the target repairing operation, repairing the communication bus comprises:
switching the central processing unit to a general purpose input/output (GPIO) inputting mode;
when the central processing unit changes from a high level to a low level in the GPIO inputting mode, switching the central processing unit from the GPIO inputting mode to a GPIO outputting mode; and
when the central processing unit changes from the low level to the high level in the GPIO outputting mode, switching the central processing unit from the GPIO outputting mode to an IIC mode.

18. The electronic device according to claim 15, wherein when the target hanging-up event is the serial-data-line hanging-up event, according to the target repairing operation, repairing the communication bus comprises:
when it is detected that the baseband processing unit is in a pulling-out state, sending a first controlling instruction to a programing logic device corresponding to the hot-plug chip, wherein the first controlling instruction is configured for controlling the programing logic device to stop supplying electric power to the hot-plug chip;
after the hot-plug chip stops operating, detecting a plugging state of the baseband processing unit; and
when the plugging state is configured for indicating that the baseband processing unit is in an insertion state, sending a second controlling instruction to the programing logic device, wherein the second controlling instruction is configured for controlling the programing logic device to start supplying the electric power to the hot-plug chip.

19. The electronic device according to claim 18, wherein sending the second controlling instruction to the programing logic device comprises:
after delaying for a predetermined duration, sending the second controlling instruction to the programing logic device;
or
detecting an initialization progress after the baseband processing unit is inserted, and when the initialization progress reaches a predetermined progress, sending the second controlling instruction to the programing logic device.

20. The one or more non-volatile computer-readable storage mediums according to claim 9, wherein determining the target hanging-up event generated by the communication bus deployed between the central processing unit and the baseband processing unit comprises:
detecting a target connecting mode at a current moment between the central processing unit and the baseband processing unit; and
according to the target connecting mode, determining the target hanging-up event generated by the communication bus, wherein the target hanging-up event comprises a serial-data-line hanging-up event and a serial-clock-line hanging-up event.

21. The one or more non-volatile computer-readable storage mediums according to claim 20, wherein the target connecting mode comprises:
the central processing unit is connected to the baseband processing unit by the communication bus;
or
the central processing unit is serially connected to a hot-plug chip and the baseband processing unit by the communication bus.
